(19) United States
(12) Patent Application Publication
(10) Pub. No.: US 2011/0091325 A1
(43) Pub. Date: Apr. 21, 2011

(54) Tool and Method for Rapid Design and Reduction of Rotor Mass

(76) Inventor: Sadeg M. Faris, Pleasantville, NY (US)

(21) Appl. No.: 12/856,797

(22) Filed: Aug. 16, 2010

Related U.S. Application Data
(60) Provisional application No. 61/252,696, filed on Oct. 18, 2009.

(51) Int. Cl. F03D 11/00; B23P 15/02; B23P 19/00

(52) U.S. Cl. 416/223 R; 29/889.7; 29/700

(57) ABSTRACT

Wind turbine rotors are designed by means of computationally intensive algorithms, simulation tools and various models. These art methods, however, have not been successful in relating the blade mass directly to the aerodynamic, rotational dynamics and material parameters. Consequently, modelers are often grappling with discrepancies and ambiguities. Prior art generally constructs the empirical relation M_{R}∝R^{ν} where ν is given a value that ranges between 1.8 and 3, depending on who, and how the experimental data is presented and compared with theoretical or simulation results. The present invention derives for the first time a precise scaling law that relates the blade mass to the cubic power of R exactly. It is based on using a novel tool in the form of a set virtual air gear teeth that intermesh with the blade gear teeth, to link the actuator disc to the rotational dynamics and material properties of the blades.

### CROSS-REFERENCE TO RELATED APPLICATIONS

This application claims the benefit of provisional patent application Ser. No. 61/252,696, filed on Oct. 18, 2009, incorporated herein by reference in its entirety.

### FIELD OF THE INVENTION

This invention is related to the design of wind turbines for harvesting and using wind power. More specifically, it is related to design tools, methodologies, and scaling laws that enable the prediction with precision the performance and cost of components and systems. Even more specifically, it is related to how the rotor blade mass is directly and accurately linked to the aerodynamic parameters resulting from the blade structure interaction with the wind energy. It is related to the recognition that the mass cubic power law is powerful tool for drastic mass reduction per unit power in the embodiments of rotor array architectures.

### BACKGROUND OF THE INVENTION

Newton's Laws of motion govern our environment and many aspects of our lives. Forces act on substances to predict, and determine and shape their behaviors. These substances can be solids, fluids, liquids or gases, made of atoms and molecules. How these masses are held together lead to many outcomes when acted upon by forces.

The wind power generation technology is experiencing spectacular successes and is growing at double digit rates into a colossal industry. Many nations have set targets to derive 20% of their energy needs from wind by year 2030. Advances in computational fluid dynamics along with Blade Element Models, and Momentum Theories, and other simulation tools and models made significant contributions to the success of the industry. These tools and models have been able to predict aerodynamics parameters that matched experiments with better than 1% accuracy. To date, these tools have been augmented by wind tunnel simulations in iterative processes to obtained the desired final design of products.

This iterative design methodology has also been adopted by other industries involving fluid dynamics. Generally in aerodynamics (fluid dynamics) based products, the engineering of these products has been far advanced ahead of the complete understanding of the fundamental science behind such products. This will be illustrated below in connection with the absence of a reliable rotor mass scaling laws. en

Unfortunately, as successful as those simulation tools and models have been, they have not yet succeeded to accurately relate the aerodynamics parameters to the rotational dynamic parameters of the rotor blade. Most notably the absence of an accurate relation or a link between the blade mass and the aerodynamics interaction with the incident wind energy. In the absence of this knowledge about the mass, the wind industry, in achieving its spectacular success, has coped by relying on trial and error iterative methods through building and experimentation and wind tunnel experiments. In addition, it employed empirical relationships, extrapolations from data regression, interpretations, intuition and costly computational tools as aids to design and make products. Finding precise formulas and scaling laws that relate the mass to geometrical, structural, and rotational ad aerodynamic properties could speed up the design and production phases, saving money in the process.

There are numerous references to discrepancies attributed to the known limitations of CFD and other simulations tools and the scalability issues of the wind tunnel results. Frequent discrepancies are associated with attempts to relate the rotor mass M_{R} to its radius, R. It is empirically presented as M_{R}∝R^{ν}, where the exponent ν varies between ˜1.9 to 3. This wide variation amounts to over 100% error. It cannot be used as a reliable tool for scaling of rotors to different sizes, design optimization and the interpretation of the rotational dynamics behavior. It may lead to over-design (too conservative) which is costly or to under-design (too aggressive) resulting in catastrophic failures.

In a report entitled “Blade Technology Innovations for Utility-Scale Turbines” by Tom Ashwill, http://windpower.sandia.gov/other/BladeTechInnovations-AWEA06.pdf, presents a graph showing rotor blade mass scaling with radius. It is reproduced here as FIG. 1. The graph emphasizes the use of different simulation tools leading to different exponents ν ranging from 2.5 to 2.9.

Scaling of mass with radius is also discussed in the Reference: http://www.wind-energy-the-facts.org/en/part-i-technology/chapter-3-wind-turbine-technology/technology-trends/rotor-and-nacelle-mass.html. FIGS. 2A and 2B show two dramatically different scaling graphs with two different exponents ν of 1.95 and 2.82 respectively. The authors further state “manufacturers are continually introducing new concepts to drive train layout, structure, and components to reduce mass and cost, but avoiding the cubic scaling (or worst when gravity loads begin to dominate) and increases system mass and cost linked to up-scaling present technology is being explored in depth in the UPWIND project. This project includes an exploration of the technical and economic feasibility of 10 and 20 MW wind turbines.”

Yet in another report entitled “Current Developments in Wind—2009”, http://www.ecn.nl/docs/library/report/2009/e09096.pdf, Engels et al, organized many turbines by their wind class. They plotted the data in three different graphs (FIGS. 4.2 and 4.3a, b) and used different regressions resulting in ν variation between 1.98 to 2.3. They compare these exponents with those predicted by to NREL's baseline model which shows ν=2.9 and the advanced model which shows ν=2.53.

In the Report # Duwind 2001.006 entitled “Offshore Wind Energy Ready to Power a Sustainable Europe” the authors present extensive experimental date and comparisons with theoretical models and discuss scaling laws and scaling trends. They state “Scaling trends need to be interpreted with great care. Data indiscriminately lumped together may suggest spurious trends or at least provide only superficial descriptions rather than insight into basic issues like the inherent specific costs (cost per kW or cost per kWh) trend with up-scaling.”http://www.google.com/#hl=en&source=hp&q=offshore+wind+energy+ready+to+power+a+sustainable+europe&aq=0&acd=g1&ag1=&oq=Offshore+Wind+Energy+ready&gs_rfai=CKB9jh0pMTK6FNIGOzQT2jtnPCgAAAKOEBU_QORmf&fp=77e1027cd91f5f34

Bilmer et al., in “Aerodynamic and Structural Design of MultiMW Wind Turbine Blades beyond 5MW”, http://iopscience.iop.org/1742-6596/75/1/012002/pdf, perform analysis of blade mass scaling showing a trend of ν=2.5 at the same time, they compared existing turbines and deduced a power law with ν=1.9. They also made reference to a theoretical exponent of 3.

In the text book “Wind Energy Explained-Theory Design and Applications”, Wiley and Sons, 2009, the authors Manwell et al., discuss on page 145 the discrepancies and ambiguities resulting from different models employing the same parameters. They state: “After the tests were completed, the measured input data, airfoil data, operational conditions, were provided to a number of modelers around the world. Nineteen modelers, using variety of aerodynamic modeling programs (some used the same program) provided predictions of rotor performance, loads and pressure coefficients for 20 different operating conditions. The results were most surprising and have highlighted many areas that still need to be addressed.”

In the Book “Wind Turbine Design”, Polytechnic International Press, Montreal, 2002, the author Ion Paraschivoiu devotes Chapter 4 to Aerodynamics Performance Prediction Models and compares results predicted by models with experiments highlighting the existence of a gap of getting accurate match.

The issue of blade mass scaling with radius is discussed in yet another reference “Wind Turbines, Fundamentals, Technologies, Applications and Economics” by Eric Hau, published by Springer-Veralg Berlin Heidelberg, 2006 (http://books.google.com/books?id=Z4bhObd65IAC&pg=PA245&1pg=PA245&dq=%22 blade+mass%22+calculation+discrepancy+wind+turbine&source=bl&ots=RLnxDMmTC3&sig=PDO134Zx7EFFaRUIoCx78-NeKcE&hl=en&ei=FoY_TKvcO4O78gbCh7zoCw&sa=X&oi=book_result&ct=result&resnum=3&ved=0CB8Q6AEwAg#ν=onepage&q&f=true). In Chapter 7.6 on Comparison of Rotor Blade Design, FIG. 7.25 shows blades mass of different turbine and blade concepts and different wind classes and blade materials. The data in the graph cannot match a single scaling law with a unique unambiguous exponent. The author states: “Empirically, the increase in blade mass with rotor diameter can be described with good approximation by exponent 2.6. The increase in specific blade mass per rotor-swept area then contains the exponent 0.6:

$${m}_{2} = {{m}_{1} ( \frac{{D}_{2}}{{D}_{1}} )}^{0.6} .$$

Strictly speaking, the exponent changes with rotor blades design. Heavy rotor blades differ from lighter blades in their ratio of the loads from intrinsic weight and the aerodynamic forces so the growth exponent becomes somewhat lighter.”

It is the desire of numerous wind energy practitioners to make the exponent smaller to reduce mass and cost. Intuitively they are aware of the existence of a “square cube law” they perceive as the barrier to reducing the mass. Even though there has not been an actual derivation and establishment of the square cube law based on fundamental scientific principles, they are determined to defeat it as though it was an enemy. They are investing heavily to defeat it without full understanding of the source and their achievements are manifested in reporting exponents that have values ranging from 1.8 to 3.

In connection to scaling wind turbines, this Reference: http://www.robedwards.com/2008/10/wind-turbines-grow-bigger-and-better.html states: “UpWind researchers are also studying the possibility of a 20-MW turbine. They have concluded that although technological barriers could be overcome, it is doubtful whether such large machines are economically viable. This is because of what wind engineers call the “square cube law”. A turbine's power output is proportional to the square of the length of its blades, making it attractive to lengthen them. But its volume and weight are proportional to the cube of its dimensions, meaning the price of a turbine climbs faster than its power output as its size increases. This suggests there will be an optimum size for a wind turbine, though so far no one has calculated what that will be.”

In discussing scaling challenges the authors in: http://www.renewableenergyworld.com/rea/news/article/2009/03/speaking-of-wind-discussions-from-germany, point out: “Elaborating on future challenges, Molly points at major design issues like load reduction, prolonging operational lifetime, and the application of new materials and production methods. One of his conclusions was that with increasing size wind turbines, suppliers succeed in curbing Top Head Mass (nacelle and rotor) increases due to increasing utilization of superior materials, despite the fact that up-scaling is inevitably linked to the infamous ‘square cube law’.”

Another reference to scaling issues in: http://www.eletaen.gr/Documents/aiolos/Texnika_ka/WIND_ENERGY_THE_FACTS_EE_DG_ENERGY_{—}1996.pdf states: “In a simplistic view of wind turbine scaling, there is often reference to a “square-cube” law. The up-scaling of wind turbines is more favorable than this suggests with the “square” part being more like 2.4 on account of the benefit of increased mean wind speed at increased height above ground. However, there is little basis for mass and costs scaling less than cubically when all variables (especially age of design) are fully taken into account.”

The Authors in: http://www.wmc.eu/public_docs/10128_{—}000.pdf add: “In order to fulfill the potential of wind energy, the development of larger wind turbines and more extensive use of offshore locations will be necessary. As the required financial investments to achieve the expansion of the installed capacity of wind turbine grows, the economical pressure on reliable and structurally optimized blades, that are fit for their designed life, increases. For large wind turbine blades, optimization of the use of material becomes necessary to tackle the problems of the square-cube law. Very large blades may even become practically impossible without further knowledge of the material behavior since the dominating loads on the material are caused by the blade mass. At the same time, the economical utilization of large wind-farms, offshore and onshore, consisting of MW wind turbines demands reliable and non-stop operation.”

The above references and many practicing wind technologists, emphasize the need to find ways to reduce the exponent in order to reduce mass and cost. They express their goals as “defeating” or “mitigating”, or “skirting”, or “avoiding” the “square cube law”. Yet, in no place in the wind prior art published literature can one find a formula or a law linking the “square cube law” to wind parameters such as blade mass.
http://www.nrel.gov/docs/fy01osti/29492.pdf;
http://www.nrel.gov/wind/pdfs/43412.pdf;
http://users.soe.ucsc.edu/˜mona/EE80j_files/wind.pdf;
http://www.wmc.eu/public_docs/10250_{—}000.pdf.

It is therefore evident from the above, that the issue of blade mass scaling with its radius and the size of exponent has received a great deal of attention and continues to be froth with controversies, uncertainties and discrepancies. One of the main reasons for this gap is a missing link bridging the aerodynamics properties of exiting theories and models with those of rotational dynamics of the rotor blades and other turbine structures. The missing link is connected with incomplete understanding of the fundamental science that lags significantly engineering and manufacturing of wind turbine products and other aerodynamic products.

There exists, therefore, a need for closing the knowledge gap by finding the missing link to bridge the aerodynamics properties of exiting theories and models with those of rotational dynamics of the rotor blades and other turbine structures.

There exists a need for a method for determining the blade mass and its relation with the radius based on sound fundamental physical principles. There is a need for a fundamental scaling law that can be used to predict the performance of a new design in terms of other previously proven reference designs. These laws would provide deep insight on how to reduce the mass of the system and the cost.

There is a need for a formula that enables scientists and engineer to interpret experimental data the same way with no ambiguity. The existence of such an invariant law or formula, would lead more rapidly to optimized turbines in terms of performance and cost. Complete understanding of the sources of mass weight is the key to its safe reduction to realize the fullest potential of the technology at the lowest cost. It may also lead to more innovative concepts and rotor configurations heretofore were not possible.

### OBJECTS OF THE INVENTION

The object of the present invention is to teach a novel tool and method for bridging the gap between the aerodynamics properties of exiting theories and models with those of rotational dynamics of the rotor blades and other turbine structures. The inventive method shows steps leading to a scaling law of rotor mass that is unambiguously cubic M_{R}=2π ρ̅_{R}R³Pᵢ, where ρ̅_{R}, and Pᵢ are respectively, the average rotor blade density, and the performance integral; all are independent of R. The method also produces the fundamentally important constraint which relates the blade mass to the weight to strength ratio of its material and to the other rotor structural and aerodynamic parameters thus:

$${M}_{R} / {T}_{m} = \frac{2 {\overline{ρ}}_{R} / {\overline{τ}}_{s}}{{C}_{p} λ} {S}_{i}$$

where Tₘ, Cₚ, λ, τ̅ₛ, and Sᵢ are respectively the maximum allowed torque, power coefficient, the tip speed ratio, the average shear strength, and the strength integral; all are independent of R.

Another object of the present invention is an embodiment to reduce the turbine system mass as a consequence of the law scaling, according to the present invention, relating the mass to the cube of the radius. It shows that smaller rotors are better than larger rotors, allowing the construction of novel wind turbine architectures which comprise an NₓN_{y} array of small rotors and an energy accumulator for accumulating energy from the array elements. This is shown to unexpectedly lead to a reduction factor \sqrt{NₓN_{y}} in the mass of the turbine system. For example, Nₓ=10 and N_{y}=10, a factor of 10 mass reduction is expected. This method is far more significant, resulting in many fold mass reduction per KW that prior art attempt to avoid the cubic power law, and achieving a mere small fraction of the reduction factor according to the present invention.

### SUMMARY OF THE INVENTION

This invention is generally, in the field of fluid dynamics that involve the interaction of fluids and their flow energy with structures leading to the conversion of translational motion of the fluid to rotational motion of the structures. These structures are referred to as rotors which comprise at least one rotor blade. The coupling strength leading to maximum conversion is determined by the fluid dynamical parameters and their interaction with the geometrical shape of the rotor blade. The geometrical shape is the well known airfoil. They are found in numerous applications including wind turbines, helicopter rotors, steam and gas turbines, air and marine propellers and pumps and compressors.

In order to optimally design rotors to achieve the lowest cost and highest reliability precise knowledge of the mass is of paramount importance. There is a need to relate the mass of the blade to the aerodynamic parameters of the fluid and the geometrical and structural properties of the airfoil. In the wind turbine industry art, one finds examples of ambiguous interpretations and discrepancies especially related to how the blade mass scales with the radius. Prior art generally constructs the empirical relation M_{R}∝R^{ν} where ν is given a value that ranges between 1.8 and 3, depending on who and how the experimental data is presented and compared with theoretical or simulation results.

I describe an inventive tool and method to eliminate this ambiguity. Steps are shown to design and produce rotor blades having a mass that obeys an unambiguous cubic power law with respect to the radius. The mass is directly related to the material geometrical, structural, rotational and aerodynamics parameters and properties.

My inventive method employs as a tool a virtual gear structure interposed between the incident air disc structure and the rotor blade structure. This provides a link between prior art analyses that use known theoretical and simulation models, by providing a direct relationship between the air disc aerodynamics and the rotor rotational dynamics. This tool, on the one hand, enables us to use the moment of inertia of the virtual air gear teeth and relates to the dynamics of the air disc through air mass conservation. On the other hand the virtual teeth moment of inertia is related to that of the rotor blades. The virtual gear tool comprises a first gear set (driver) that intermeshes with a second gear set (driven). The first gear set derives its rotational power from the actuator air (fluid) disc.

Thus, using the virtual gear tool, our construction method leads to the blade mass scaling law that is unambiguously cubic M_{R}=2π ρ̅_{R}R³Pᵢ, where ρ̅_{R}, and Pᵢ are respectively, the average density, and the performance integral; all are independent of R. The method also produces the fundamentally important constraint which relates the blade mass to the weight to strength ratio of its material and to the other rotor structural and aerodynamic parameters thus:

$${M}_{R} / {T}_{m} = \frac{2 {\overline{ρ}}_{R} / {\overline{τ}}_{s}}{{C}_{p} λ} {S}_{i}$$

where Tₘ, Cₚ, λ, τ̅, and Sᵢ are respectively the maximum allowed torque, power coefficient, the tip speed ratio, the average shear strength, and the strength integral; all are independent of R.

These two formulas in combination, are the desired rules that enable rotor designers to gain simple yet powerful insight into how to manufacture turbines. They provide precise systematic steps to take, to optimize products in terms of reliability, manufacturability, safety, cost and other desirable product features. The performance and strength integrals are independent of R and contain only information about the local geometry of the airfoil, its orientation relative to the fluid and its surface properties that determine the lift/drag coefficient ratio. These culminate in the determination of the local power coefficient, cₚ(λᵣ), which is a function of the local tip speed ratio λᵣ.

The local power coefficient, cₚ(λᵣ), is obtainable from existing successful formulations using well developed tools including computational fluid dynamics models, Blade Element Models, Momentum Theories and other graphical simulation tools. The availability of cₚ(λᵣ) from these known methods enables the designers to obtain with much less effort the values for the strength integral, Sᵢ and the performance integral Pᵢ, without with concerns as to the validity of the models and prior ambiguities. The inventive method enables the designers with less effort to conceive innovative geometries and over all turbine structures that lead to the reduction of cost power ($/KW) and the cost of energy ($/MWh).

The inventive tools and method leading to the precise scaling law manifests its powerful impact in the reduction of mass per KW by factors exceeding 10. The direct consequence the scaling law of the present invention is a newer design trend leading to better performance and lower cost with smaller rotors. This is opposite to the “prevailing wisdom” of the prior art which continues to make larger and larger rotors that weigh hundreds of tons and measure>100 m. By arranging a plurality of smaller rotors, according to the present invention, a novel wind turbine array architecture becomes possible. It comprises an NₓN_{y} array of small rotors and an energy accumulator for accumulating energy from the array elements. This is shown to unexpectedly lead to a reduction factor \sqrt{NₓN_{y}} in the mass of the turbine system. For example, Nₓ=10 and N_{y}=10, a factor of 10 mass reduction is possible. This method is far more significant, resulting in many fold mass reduction per KW than prior art attempt to avoid or circumvent the fundamental cubic power law, and achieving a mere small fraction of the reduction factor.

The present invention uses wind turbine as an exemplary application to illustrate the inventive steps. Persons skilled in the art may readily apply the method for the design and production of fluid dynamics structures in any other applications. Particularly, those which involve the interaction of fluids with airfoils or related structures for converting translational fluid energy into rotational energy mechanical energy. The inventive method can also be used in propellers and helicopter rotors, wherein rotational mechanical energy is converted to translational fluid energy to produce linear propulsion thrust.

### BRIEF DESCRIPTION OF THE DRAWINGS

The following drawings are intended to describe the preferred embodiments and operating principles. They are not intended to be restrictive or limiting as to sizes, scales, shapes or presence or absence of certain necessary components that are not shown for brevity but are, nonetheless, well known to those skilled in the art.

FIG. 1 shows prior art graph of the blade mass and how it scales with the radius. Different models produce different exponents.

FIGS. 2A-2B Show other exemplary prior art graphs showing mass scaling with radius, again different exponents are produced.

FIG. 3A shows the an exemplary of radius R and a number of blades B covered by an air disc area with radius R.

FIG. 3B shows the same structures of FIG. 3A to which an intermediate virual gear structure is added, interposed between the rotor and the top air disc structure.

FIGS. 3C-3E are a side views of the cross section A-A of the three structures taken at an arbitrary radius r, revealing the airfoil shape, its cross sectional area and the volume of the virtual gear tooth element between two air foils taken at annual region of radius r.

FIGS. 4A-4B illustrate wind array architecture according to the present invention comprising clusters of small rotors transmitting their harvested energy an accumulator.

FIG. 4C is a conventional (prior art) single large rotor arrangement occupying the same swept area as that of the array in FIG. 4A.

FIG. 5A illustrates exemplary cluster topographies and configurations for use in the present inventive array architectures.

FIG. 5B is an illustration of nested cluster concept.

FIG. 5C illustrates the use of nested clusters to construct array structures to fill different regions of the power spectrum.

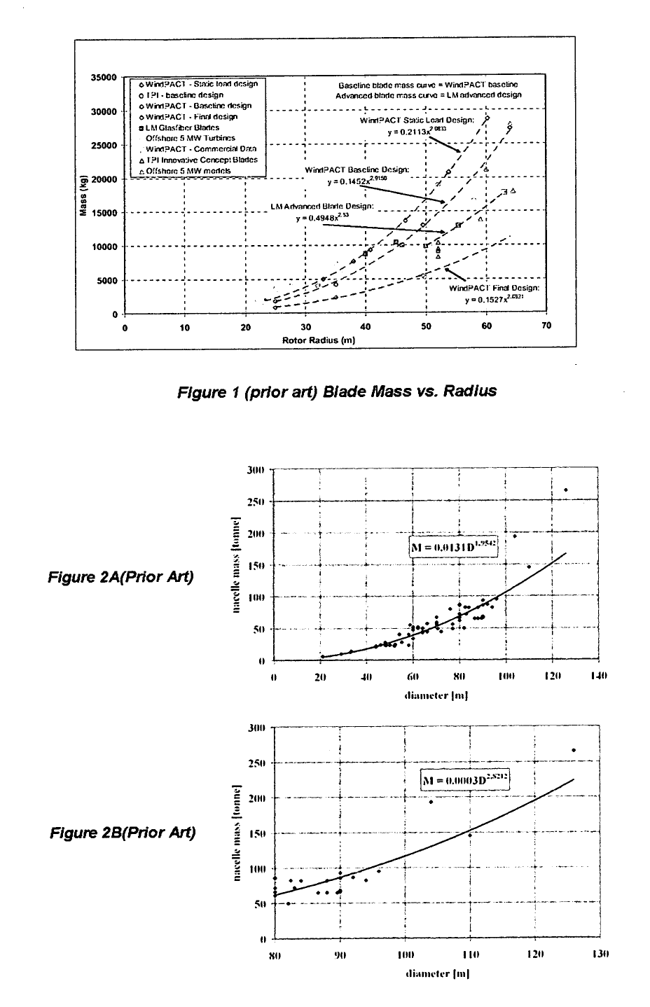

### DESCRIPTION OF THE PREFERRED EMBODIMENTS

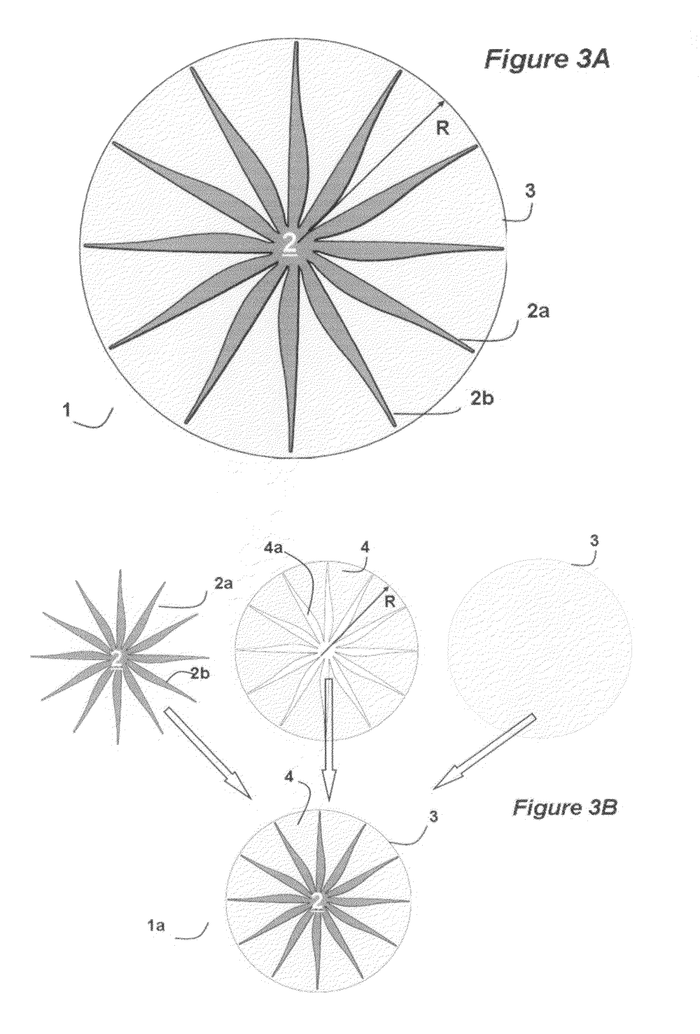

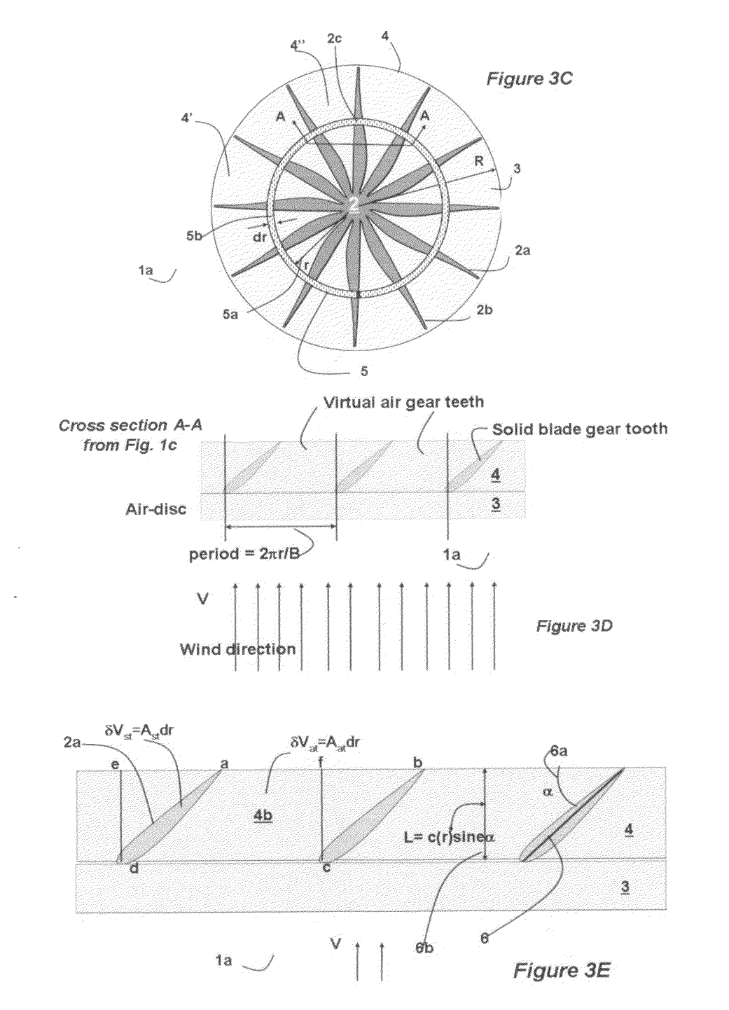

As shown in FIG. 3A, conventionally when analyzing the air (fluid) dynamical interaction between wind having translational velocity V (also other fluids), a structure 1, comprising a rotor structure 2, an air (fluid) disc 3, of radius R are used. The disc which is also referred to as the actuator disc, is placed on top of the rotor. The arrangement has been successfully used by many well developed computational and simulation tools including: computational fluid dynamics models, Blade Element Models, Momentum Theories and other graphical simulation tools. These tools have lead to predictions of the local cₚ(λᵣ) power coefficient as a function of the local tip velocity ratio λᵣ at an annular region of area 2πrdr (defined in FIG. 3C) and the power coefficient Cₚ(λ) as a function of the largest allowed tip velocity ratio λ at r=R.

The detailed analyses of various prior art formulations are found in the text books cited above. The results of these theoretical analyses and simulations matched experimental measurements, in many cases to better than 1% accuracy. However, a missing link has existed to bridge the gap between the air disc 3 aerodynamic and the rotation dynamics that inevitably involves the rotor blades mass, and its physical properties. The gap manifests itself in the ambiguities and discrepancies described in the Background Section between simulation results, wind tunnel measutments and actual data from products.

The present invention provides a tool and method to link and close the gap. When used with existing prior tools, the invention is an additional helpful augmentation tool. The preferred embodiment comprises the tool 1a in FIG. 3B. This tool structure is referred to as a virtual gear set comprising: an air disc structure 3, connected to a first gear set 4 (driver gear) which in turn rotationally drives the second gear set 2, the teeth of which are the rotor blades 2a, 2b. The first virtual gear set has “teeth” 4b, 4c, made up of the volume between the rotor blade teeth. The top center structure of FIG. 3B helps further the visualization the virtual gear teeth by noting the void sections 4a. The “gray” volume comprises the virtual teeth which intermesh with the rotor blade teeth at sections 4a. The construction of the final inventive structure 1a, is shown at the bottom of the figure by interposing the virtual gear 4 between the top air disc 3, and the blade gear teeth 2, intermeshed at the bottom of 4.

FIGS. 3A-3E present cross sectional (axial) views to visualize the relative positions of the structures 2, 3, 4. They also show how they interact with the wind of velocity V incident axially on the air disc structure 3. The wind arrives from infinity as parallel axial air streams with a translational velocity V. Just before it interact with the actuator disc 3, it blows over the disc of radius R with a power given by P_{D}=0.5ρ₀AV³=0.5ρ₀πR²V³, where ρ₀ is the air density (varies with temperature, pressure , altitude). This air mass from the actuator disc 3, enters the 3 dimensional virtual air tooth volume δVₐₜ 4b, between blade teeth and begins to interact with the 3 dimensional airfoil shaped blade teeth 2a. As is well known in the aerodynamics art, the lift and drag forces supplied by the incident air energy, locally convert part of the translational velocity into tangential velocity. Then a steady state rotational motion at an angular velocity ω is established, enabling the virtual driver gear teeth 4, to drive the solid blade gear teeth 2.

The local conversion efficiency, also refereed to as the local power coefficient, is given the symbol cₚ(λᵣ) which is a function of the local tip velocity ratio λᵣ, at an annular region of area 2πrdr (defined in FIG. 3C). The largest allowed tip velocity ratio λ at r=R, yields the power coefficient Cₚ(λ) which is constrained by the well known Betz Law of 16/27˜0.593. Well optimized wind turbines achieve between 0.4 and 0.5.

### I. Mass Cubic Scaling Law and Performance Intergral

We now present steps, or algorithms, leading to the design and production of turbine blades. Our method leads to simple unambiguous laws and formulas that relate the blade properties and parameters to those of the aerodynamics properties of its environment. These include the blade 3D geometry, its structure, its material strength, its mass density, the turbine radius and the predicted harvested power and energy performance and cost.

Step 1: Providing the statistical meteorological knowledge of the environment where the turbine is located.

Step 2: Providing the maximum allowable wind velocity (cut-out speed) above which the turbine will be stopped before it is damaged by gale winds and other storms. This enables the designer to select suitable blade strength; its weight to strength ratio becomes the key design decision.

Step 3: Providing the average velocity (rated speed) to enable the designer to commit to a rated output power and the energy to be harvested as main product specifications. Different geographical regions have different wind classes that refer statistically to the potential energy harvest from that region. Exemplary wind velocities range from 5 m/s to 35 m/s.

Step 4: Providing the rotor radius R, from steps 2 and 3

Step 5: Linking the local (at radius r) rotational dynamics of the virtual air gear teeth 4, to the actuator disc dynamics by means of equating the local rotational power of the virtual gear teeth 4, to the local fraction cₚ(r) of the rotational power in the actuator disc 3. Thus:

$$\begin{matrix}δ {P}_{at} = \frac{1}{2} δ {I}_{at} {ω}^{3} = \frac{1}{2} {ρ}_{o} {r}^{2} δ {V}_{at} {ω}^{3} = \frac{1}{2} {ρ}_{o} {r}^{2} {A}_{at} dr {ω}^{3} & ( 1 ) \\ δ {P}_{d} = \frac{1}{2} {ρ}_{o} ( 2 π rdr / {λ}_{r}^{3} B ) {r}^{3} {ω}^{3} & ( 2 ) \\ δ {P}_{at} = {c}_{p} ( r ) δ {P}_{d} & ( 3 )\end{matrix}$$

From Eqs. (1), (2) and (3) we link the infinitesimal volume element Aₐₜdr 4b, occupied by the single virtual air gear tooth 4a, to the aerodynamic parameters. The area Aₐₜ is defined in FIG. 3E by the lines (abcd). It is found to be:

$${A}_{at} = \frac{2 π {c}_{p} ( r )}{B {λ}_{r}^{3}} {r}^{2} \qquad ( 4 )$$

Step 6: We produce the infinitesimal local, at radius r, the mass element 2a, of a single blade tooth with a density of ρ_{R}(r) and an airfoil cross section area Aₛₜ which is equal to the cell area defined by the lines (efcd) in FIG. 3E minus the virtual tooth area Aₐₜ. Thus

Aₛₜ=A_{c}−Aₐₜ (5)

From Step 5 we use Eq. 4 in Eq. 5 to produce the cross section area of the solid blade tooth airfoil cross section area:

$${A}_{st} = {A}_{c} - \frac{2 π {c}_{p} ( r )}{B {λ}_{r}^{3}} {r}^{2} \qquad ( 6 )$$

Step 7: Producing the local mass element at r of a single solid blade tooth:

$$δ {M}_{R} = {ρ}_{R} ( r ) {A}_{st} dr = {ρ}_{R} ( {A}_{c} - \frac{2 π {c}_{p} ( r )}{B {λ}_{r}^{3}} {r}^{2} ) dr \qquad ( 7 )$$

Step 8: Producing the total mass of a single blade tooth by integrating Eq. 7 from the hub r=rₕ to r=R to obtain M_{R}, thus:

$${M}_{R} = {\int }_{{r}_{h}}^{R} {ρ}_{R} ( {A}_{c} - \frac{2 π {c}_{p} ( r )}{B {λ}_{r}^{3}} {r}^{2} ) d r \qquad ( 8 )$$

Step 9: Calculating the cell area A_{c} at r, defined by the lines (efcd) in FIG. 3E which is equal to the period defined in FIG. 3D:

A_{c}=2πrL/B=2πrc(r)sin α/B (9)

To obtain the desired result:

$${M}_{R} = {\int }_{{r}_{h}}^{R} {ρ}_{R} ( r ) ( \frac{2 π rc ( r ) sin α}{B} - \frac{2 π {c}_{p} ( r )}{B {λ}_{r}^{3}} {r}^{2} ) d r \qquad ( 10 )$$

Which relates the whole single blade mass geometrical and material properties to the aerodynamic properties, including, the airfoil chord c(r), angle of attack α 6a, blade number B, local tip speed velocity λᵣ, local power coefficient cₚ(r) which embodies lift and drag coefficients and Reynolds's number and of course through Rω=λV and Rω=λVₘ the relation to the operating and maximum velocities. In this example, the airfoil chord c(r) varies with the rotor radius. It can, however, be made with any arbitrary cross section that varies with r, θ, z (axial) coordinates. Existing turbine blades designs include an angular twist of the chord that varies with r. This makes the angle of attack α varies locally with the radius.

Step 10: Providing a law or a recipe that relates the blade mass to a pure cubic power with respect to the radius. This is accomplished with the help of change of variable to cast the relevant parameters in dimensionless normalized values:

$$1. \qquad Let \frac{{λ}_{r}}{λ} = \frac{r}{R} , and \frac{d {λ}_{r}}{λ} = \frac{d r}{R}$$

2. Let the normalized chord of the airfoil be c_{f}(λᵣ)=c(r)/R, then Eq. (10) can be recast as:

$${M}_{R} = 2 π {R}^{3} {\int }_{{λ}_{h}}^{λ} \frac{{ρ}_{R} ( {λ}_{r} )}{{λ}^{3} B} ( ( λsin α ) [ {λ}_{r} {c}_{f} ( {λ}_{r} ) ] - \frac{{c}_{p} ( {λ}_{r} )}{{λ}_{r}} ) d {λ}_{r} \qquad ( 11 )$$

We now define the power integral:

$${P}_{i} ≡ {\int }_{{λ}_{h}}^{λ} \frac{{ρ}_{R} ( {λ}_{r} ) / {\overline{ρ}}_{R}}{{λ}^{3} B} ( ( λ sin α ) [ {λ}_{r} {c}_{f} ( {λ}_{r} ) ] - \frac{{c}_{p} ( {λ}_{r} )}{{λ}_{r}} ) d {λ}_{r} \qquad ( 12 )$$

This results in the desired law that relates the mass to the cubic power of the radius:

M_{R}=2π ρ̅_{R}R³Pᵢ (13)

Here we define ρ̅_{R} as the average blade density. It is important to emphasize that the performance integral Pᵢ is independent of R. It is a function of only dimensionless normalized parameters and ratios. This is the first time an explicit precise relationship between the blade mass and the cubic power law, and in terms of geometrical, structural and aerodynamics properties. For any specific airfoil parameters set, the definite performance integral Pᵢ can readily be found so that an optimized rotor design can be found that meets the desired specifications.

Our inventive method to produce the scaling law represented by Equation 13 solves the problem of ambiguity, uncertainties and discrepancies plagued prior art practitioners who had available only the empirical M_{R}∝R^{ν} with exponent ν that varied between 1.8 and 3 as discussed extensively in the Background Section above.

Producing the scaling law of Eq. (13) determines the performance of the blades. However, it cannot be used arbitrarily without being constrained by strength of the blade material and structure. The mass in Eq. (13) is matched with a mass that obeys the companion law

$${M}_{R} / {T}_{m} = \frac{2 {\overline{ρ}}_{R} / {\overline{τ}}_{s}}{{C}_{p} λ} {S}_{i}$$

which relates the performance integral Pᵢ in Eqs. (12), (13) to the strength integral Sᵢ to be derived below.

### II. Blade Mass and Strenght Intergral

We now show the second embodiment of the present invention which is a method and steps to produce mass scaling with respect to strength to weight ratio of the blade material represented by the strength integral Sᵢ.

Step 11: Producing the moment of inertia δI_{R} of the local blade tooth element at point r, to get:

δI_{R}=r²δM_{R}=ρ_{R}LδJ (14)

### Where

$$L = \frac{{c}_{f}}{R} sin α ,$$

and δJ=δTₘr/τₛ, is the local polar moment of inertia of the blade element at r, δTₘ is local the maximum allowed torque at r, produced by the maximum wind velocity Vₘ, at point r, and τₛ is the shear strength that opposes the maximum torque before a permanent damage results to the blade. Substituting δJ and L in Eq. (14) to relate the local mass element δM_{R} to the maximum torque and the strength of the material, thus:

δM_{R}=ρ_{R}Rc_{f} sin α δTₘ/rτₛ (15)

Step 12: Producing the maximum torque element δTₘ using Eqs. (2) and (3) and setting Vₘ=rωₘ/λᵣ to get:

δTₘ=δPₐₜ/ωₘ=πρ₀(cₚ(r)Vₘ²r²dr/λᵣB) (16)

Step 12: Producing the blade mass relationship to the strength integral by using Eq. (16) in Eq. (15) and setting Eₘ=0.5ρ₀Vₘ² to obtain:

$$δ {M}_{R} = \frac{2 {πρ}_{R} {E}_{m} R}{{τ}_{s} B λ} sin α ( {c}_{f} {c}_{p} ( r ) r d r / {λ}_{r} ) \qquad ( 17 )$$

Then by substituting

$$\frac{{λ}_{r}}{λ} = \frac{r}{R} , \\ and$$

$$\frac{R d {λ}_{r}}{λ} = \frac{d r}{R} ,$$

Eq. (17) becomes:

$$δ {M}_{R} = \frac{2 π {E}_{m} {R}^{3}}{B {λ}^{3}} \frac{{ρ}_{R}}{{τ}_{s}} sin α ( {c}_{f} {c}_{p} ( r ) d {λ}_{r} ) \qquad ( 18 )$$

Integrating Eq. (18) we obtain the mass of a single blade related to its material strength, geometry and maximum velocity as well as other aerodynamic parameters:

$${M}_{R} = \frac{2 π {E}_{m} {R}^{3}}{B {λ}^{2}} {\int }_{{λ}_{h}}^{λ} \frac{{ρ}_{R}}{{τ}_{s}} sin α ( {c}_{f} {c}_{p} ( r ) ) d {λ}_{r} \qquad ( 19 )$$

From Eq. (16), the total rotor maximum torque

Tₘ=πCₚ(λ)Eₘ R³/λ (20)

Dividing (19) by (20) we obtain:

$${M}_{R} / {T}_{m} = \frac{2 {\overline{ρ}}_{R} / {\overline{τ}}_{s}}{{C}_{p} λ} {\int }_{{λ}_{h}}^{λ} \frac{{ρ}_{R} / {\overline{ρ}}_{R}}{{τ}_{s} / {\overline{τ}}_{s}} sin α ( {c}_{f} ( {λ}_{r} ) {c}_{p} ( {λ}_{r} ) ) d {λ}_{r} \qquad ( 21 )$$

We define the strength integral:

$${S}_{i} ≡ {\int }_{{λ}_{h}}^{λ} \frac{{ρ}_{R} / {\overline{ρ}}_{R}}{{τ}_{s} / {\overline{τ}}_{s}} sin α ( {c}_{f} ( {λ}_{r} ) {c}_{p} ( {λ}_{r} ) ) d {λ}_{r} \qquad ( 22 )$$

and τ̅ₛ, the average shear strength, so that we obtain our final companion law of the single blade mass which results in a strong safe design up to the maximum toque. This is given by:

$${M}_{R} / {T}_{m} = \frac{2 {\overline{ρ}}_{R} / {\overline{τ}}_{s}}{{C}_{p} λ} {S}_{i} \qquad ( 23 )$$

The combination of the two laws Eq. (13) and Eq.(23) describe completely the rotor in terms of all the design parameters including: material, structure, aerodynamic and rotational dynamic characteristics. Both Sᵢ and Pᵢ integrals require c_{f}(λᵣ) and cₚ(λᵣ), which are readily obtainable to evaluate the integrals. Matching the results from (13) and (23) in a self consistent manner, using the same set of parameters, c_{f}(λᵣ) and cₚ(λᵣ) in both, yields rotor designs that are optimized not only for performance but also for strength and reliability. From Eqs. (13) and (23) it can be shown also that Sᵢ and Pᵢ are related thus:

Pᵢ/λ=EₘSᵢ (23a)

Matching Sᵢ and Pᵢ according to Eq. (23a) is the central premises behind the inventive method since it ensures that no design parameter is arbitrarily determined. In other words, optimizing the blades for performance must be accomplished with the constraints of strength and reliability.

Prior art tools and methods are computationally intensive using the most powerful supercomputers in order to obtain the aerodynamics power coefficients for different airfoil geometries aerodynamics losses and the like. These methods, however, have not been able to produce explicit relationships like those in the Eq. (13) and Eq. (23) and Eq. (23a) that enable designers to rapidly make changes and improvements. Now it is possible to take a proven successful design and scale it up or down with confidence that the predicted performance will be realized and without the use of supercomputers.

The tools and methods according to the present invention can be employed not only in the field of wind power harvesting, but also in any field of fluid dynamics that involves the conversion of fluid flow energy to rotational mechanical energy of rotor blade structures to perform work. Persons skilled in the art will find Eqs. (13) and (23) generally useful as design aids in other fields. It can be shown that the inventive tools can be applied not only to horizontal axis turbines but also to vertical axis turbines and a combination thereof.

In an exemplary conventional wind turbine system the rotational power (Eq. 3) is transmitted via the rotor hub, to the power train for conversion to electrical power. The power train, which is housed in the nacelle, comprises: the main shaft, gear box, generator. The nacelle also comprises pitch and yaw mechanisms and other ancillary subsystems as needed. In direct drive systems, the rotor drives directly the generator. The system also includes the tower and the foundation. The cost of the whole turbine system is directly related to the sum of the masses of all these components. All the masses are referenced to the rotor mass, i.e., the whole system mass is a large multiple of the rotor mass. Therefore, any reduction in rotor mass has a huge leverage in the overall system cost reduction. It highlights the significance of the present invention ability to provide the tools Eq.(13) and Eq.(23) that unambiguously predict the masses in relation to all other parameters and lead the designers to means of reducing the mass and thereby the cost as shown below. Basically, can show that not only does the rotor mass scale with the cube of the radius but the entire system performance and cost scales with the cube of the radius.

### III. Mass Reduction and Rotor Array Architecture

In wind turbines systems, the mass of the blade plays the most critical role in the economic success of harvesting and delivering energy cost competitively and profitably. It has a direct impact on the initial capital cost, the cost of energy, performance, failure modes, tower and foundation design, and on the environment. Therefore, the fundamental understanding of blade mass dependence on the design parameters and predicting how it scales with these parameters is the most important task. Prior art design practices have been to rely on a fundamentally misunderstood empirical scaling formula with the hope to reduce the mass of the blade. To date, the success has been marginal reduction at best. The lack of understanding may lead to lower weight but at the expense of less reliable blades that will fail in few years. We now show that accepting the scaling as taught according to the present invention, and embodied in Eqs. (13), (23), and (23a) as a fundamental law with an invariant exponent of 3, much bigger gains in mass reduction can be achieved. In fact reduction factors in excess of 10 will be realized. These gains are direct consequence of Eq. (13) applied to an array architecture comprising a plurality of small diameter rotors according to our third preferred embodiment which is now described.

The total system mass of turbine power generators is the sum of all the masses:

M_{sys}=M_{R}+M_{hub}+M_{generator}+M_{tower}+M_{foundation} (24)

We know that bearing capacity, and the mass of the foundation is directly related to the total mass of the tower, the nacelle and the rotor masses. The tower mass is also directly related the nacelle and the rotor masses. We can therefore rewrite the masses normalized (as ratios) to the rotor mass M_{R} thus:

M_{sys}=M_{R}[(1+m_{hub}+m_{g})+mₜ+m_{f}] (25)

wherein m_{hub}=M_{hub}/M_{R}; m_{g}=M_{gen}/M_{R}; mₜ=M_{tower}/M_{R}; m_{f}=M_{foundation}/M_{R} Let the normalized nacelle weight nₘ_{hub}+m_{g}, let normalized tower mass mₜ=t(1+n) and let the normalized foundation mass m_{f}=f [mₜ+(1+n)]=f(1+n)(1+t), the system mass in Eq. (25) becomes:

M_{sys}=M_{R}(1+n)(1+t)(1+f) (26).

Then by substituting for M_{R} its cubic relation to the radius, from Eq. (13) according to the present invention, we can describe the turbine system relative to all its parameters by the following relation:

M_{sys}=2π ρ̅_{R}BPᵢR³(1+n)(1+t)(1+f) (27)

The first term 2π ρ̅_{R}BPᵢR³ of Eq. (27) was described according to the first embodiment.

The second term (1+n), is referred to as the Top Head Mass (THM) which is normalized to the rotor mass (2π ρ̅_{R}BPᵢR³) and ranges between 3 for direct drive turbines and 12 in less advanced designs. In absolute mass terms, THM may have values in the range of 50 to 300 ton.
The third term (1+t), is the tower multiplier factor which has values in the range of 1.5-2 and sometimes higher. The fourth term (1+f) is the foundation multiplier factor and has values that range from 2-5, depending on whether the turbine is located on shore, or off-shore. For off-shore locations, (1+t)(1+f) is not only large, but its specific cost/Ton is also very high. According to Eq. (27), it can be seen that the cost of the whole systems is directly related to R³, and the rotor mass has the biggest influence through the multiplier the whole (1+n)(1+t)(1+f) that can range from 12 to 200. For example, a mere 1 ton reduction in the rotor mass leads to a system mass reduction of more than 12 to 200 tons. This influence of the multiplier effect is the basis for this third embodiment which shows that rotor mass reduction of 10× leads a reduction of 100-500× reduction for the whole system for each KW!

Prior art has pursued advanced architectures aimed at increasing R, but reducing the multiplier (1+n)(1+t)(1+f). But practical constraints have not left much room for drastic reduction (1+n)(1+t)(1+f). Contrary to prior art trends of pursuing larger R, we show that smaller R is better in our novel inventive array architectures. It is a direct consequence of the foundation of our first preferred embodiment that enabled cubic power law. The previous unavailability or the wishful thinking that the cubic had not existed, has been the cause of missed opportunities by prior art investigators and their inability to achieve an unexpected result to drastically reduce the mass by \sqrt{NₓN_{y}} as shown below.

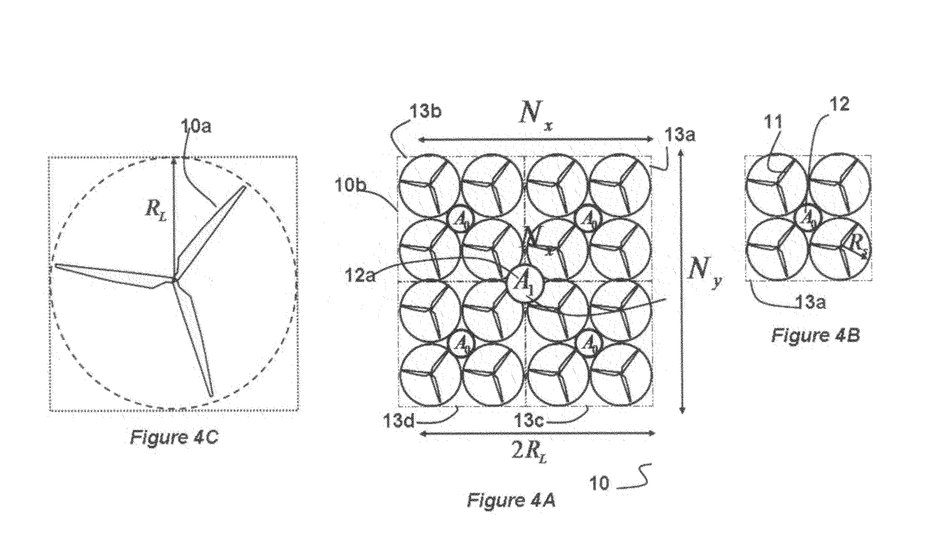

FIGS. 4A-4B illustrate a two dimensional array 10, according to the present invention, of Nₓ,N_{y} rotor elements having a small radius Rₛ. The array 10, comprises 4 clusters 13a, 13b, 13c, 13d each comprises 4 rotors 11, of radius Rₛ and an accumulator A₀ 12. The rotors transmit their energy to accumulator A₀ of each cluster 13a, 13b, 13c, 13d. The four accumulators A₀ 12 transmit their energy to a higher level accumulator A₁ 12a. This energy is either transmitted to the ground or to yet a higher level accumulator not shown. Means for transmission energy from rotors to accumulators may be in the from mechanical reciprocating transmission lines, ReXL, described in my Provisional Patent Applications Ser. No. 61/252,696, filed on Oct. 18, 2009. Optionally, electrical line transmission lines may be used as well as a combination of both.

The array 10 occupies an array sweep area, ASA=πNₓNₓRₛ²=πNRₛ² (N=NₓNₓ) which is equal to πR_{L}² the swept area of the large rotor 10a of radius R_{L}. If the small rotor array 10 and the large rotor 10a receive substantially the same wind velocity, and have the same swept area, them form Eqs. (1)-(3), they will harvest the same energy and, every thing else being equal, their radii must be related by:

$$\frac{{R}_{L}}{{R}_{s}} = \sqrt{N} \qquad ( 28 )$$

The key performance metric of wind turbine products is the cost per KW of power harvested. This cost is directly related to the mass of the system as described by Eq. (27). The mass per KW of harvested power of the array and that of large rotors are obtained from Eq. 13 by dividing by their powers, respectively by:

$$\frac{1}{2} {πρ}_{o} {C}_{p} {R}_{s}^{2} {V}^{3} and \frac{1}{2} {πρ}_{o} {C}_{p} {R}_{L}^{2} {V}^{3}$$

to obtain:

$${M}_{R}^{s} / KW = \frac{2 π {\overline{ρ}}_{R} {BR}_{s}}{{ρ}_{o} {C}_{p} {V}^{3} {λ}^{3}} {P}_{i} \qquad ( 29 )$$

for the array 10, and

$${M}_{R}^{L} / KW = \frac{2 π {\overline{ρ}}_{R} {BR}_{L}}{{ρ}_{o} {C}_{p} {V}^{3} {λ}^{3}} {P}_{i} \qquad ( 30 )$$

For the large rotor 10a. The ratio of the masses per KW (also cost ratio) is obtained from (29) and (30) as

$$\frac{{M}_{R}^{L} / KW}{{M}_{R}^{s} / KW} = \frac{{R}_{L}}{{R}_{s}} \qquad ( 31 )$$

By substituting (28) in (31) we obtain for the mass/KW ratio:

$$\frac{{M}_{R}^{L} / KW}{{M}_{R}^{s} / KW} = \sqrt{N} \qquad ( 32 )$$

This is the proof that our inventive array architecture according to this invention will cost a factor of \sqrt{N}=\sqrt{NₓN_{y}} less than if we had used a large rotor to harvest the same power.

Now returning to Eq. (27) that describes the mass of the wholes turbine system, and using Eqs. (17) and (30)-(32) the system masses per KW of the large rotor and that of the array 10, are respectively given by:

$$\begin{matrix}{M}_{sys}^{L} / KW = \frac{2 π {\overline{ρ}}_{R} {BR}_{L}}{{ρ}_{o} {C}_{p} {V}^{3} {λ}^{3}} {P}_{i} \cdot ( 1 + n ) ( 1 + t ) ( 1 + f ) & ( 33 ) \\ {M}_{sys}^{s} / KW = \frac{2 π {\overline{ρ}}_{R} {BR}_{s}}{{ρ}_{o} {C}_{p} {V}^{3} {λ}^{3}} {P}_{i} \cdot ( 1 + n ) ( 1 + t ) ( 1 + f ) & ( 34 )\end{matrix}$$

And their ratios as:

$$\frac{{M}_{sys}^{L} / KW}{{M}_{sys}^{s} / KW} = \sqrt{N} \qquad ( 35 )$$

Proving that at the wind turbine system level, the array architecture 10, has a factor \sqrt{N} cost advantage over the large rotor based turbine system.

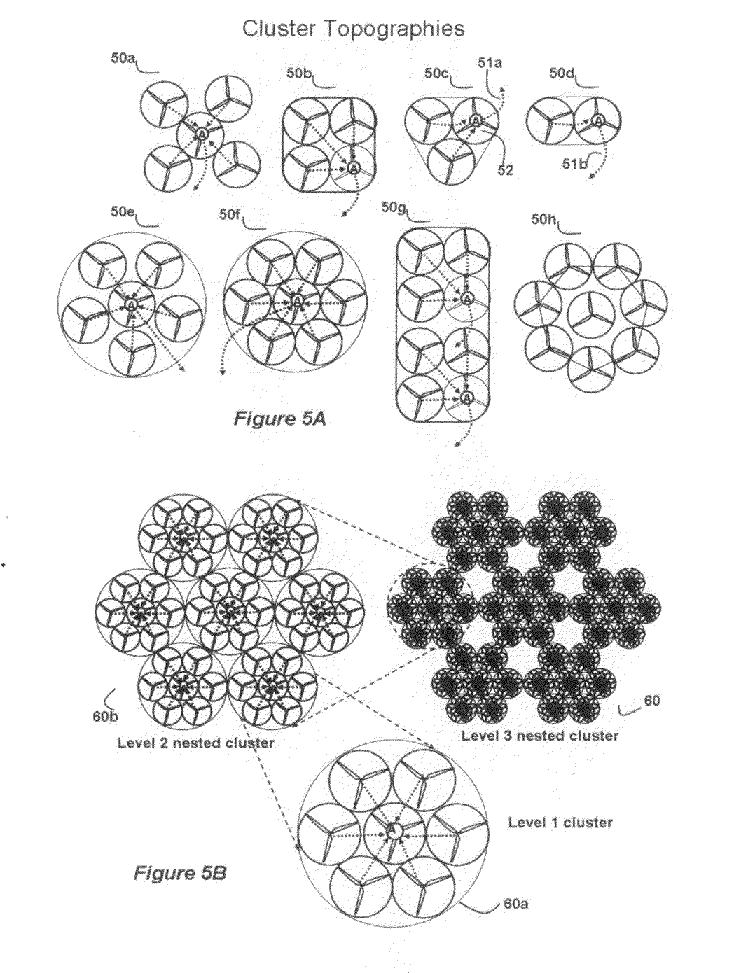

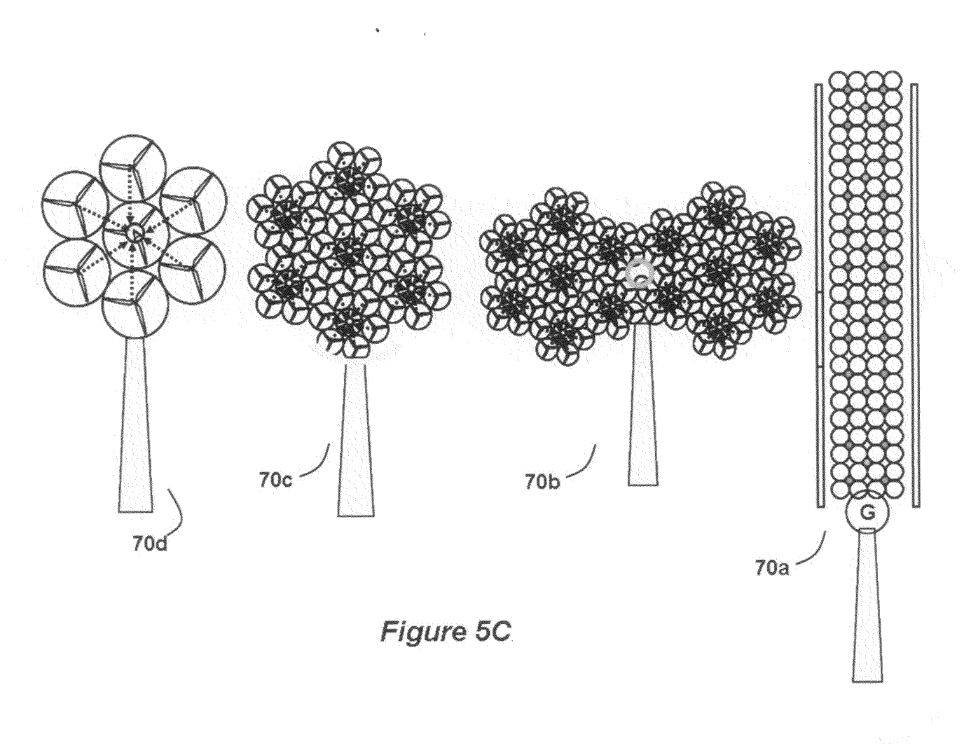

The inventive features of the preferred embodiments of the present invention, Eqs. (13), (23), (23a), (27) and (31), in combination, culminate in the ability to describe the entire turbine systems by means of a set of equations presented below for an array of NₓN_{y} rotors where NₓN_{y} is at least 1 and preferably in clusters of n_{c} rotors, n_{c}=NₓN_{y} and more preferably in nested clusters NₓN_{y}=(n_{c})^{m} where m is the cluster nesting level (see below and FIG. 5):

$$\begin{matrix}{M}_{sys}^{s} = 2 π {\overline{ρ}}_{R} B ( {N}_{x} {N}_{y} ) {P}_{i} {R}_{s}^{3} ( 1 + n ) ( 1 + t ) ( 1 + f ) & ( 36 a ) \\ {M}_{sys}^{s} / KW = \frac{2 π {\overline{ρ}}_{R} {BP}_{i} {R}_{s}}{{ρ}_{o} {C}_{p} {V}^{3} {λ}^{3}} ( 1 + n ) ( 1 + t ) ( 1 + f ) & ( 36 b ) \\ {M}_{sys}^{s} / KW = \frac{2 π {\overline{ρ}}_{R} {BP}_{i}}{{ρ}_{o} {C}_{p} {V}^{3} {λ}^{3}} ( \frac{{R}_{L}}{\sqrt{{N}_{x} {N}_{y}}} ) ( 1 + n ) ( 1 + t ) ( 1 + f ) & ( 36 c )\end{matrix}$$

We can, for the first time, describe the mass of a turbine system that can be by reduced by reducing the diameter of the small rotor and by increasing the number of these rotors to deliver the same power as an equivalent swept area of a large rotor R_{L}. The rotor mass reduction is leveraged further through the multiplier (1+n)(1+t)(1+f) and will reduce the cost of the tower and foundation by enormous factors. The system, according to Eqs. (36a), (36b), (36c) is transparently related to all the relevant design parameters including: aerodynamic and rotational dynamic parameters, airfoil shape, structures, material properties (strength through Eq. (23a), blade number B, tip speed velocity; average wind velocity, maximum allowed velocity, power coefficient; nacelle, tower and foundation weight multipliers; and the number of elements in the array, NₓN_{y}.

This array architecture applies to other fluid dynamic-based systems including vertical wind rotor array, steam and gas turbines, compressors and pumps as examples.

FIG. 5A illustrates clusters having different topographies 50a-50g. Symmetrical topographies are preferred because they lead to equal path lengths from rotors to accumulators. Each cluster topography comprises a number of rotors n, an accumulator 52, and a connector to the next cluster level 51a, 51b. If a cluster with n_{C} rotors and a specific topography forms or constructs a second cluster of the same topography and n rotors, this is refereed to as a homogeneous nested cluster of level 2. From level 2 cluster, a third nested cluster may be constructed. Nesting may continue to the M^{th} level and the number of rotors in the m^{th} level nested structure is given by (n_{C})^{m}. If m level nested clusters do not have the same topography, then they are referred to as heterogeneous nested structures.

FIG. 5B illustrates a third level nested cluster 60 constructed from the hexagonal topography cluster as the building block 60a. The building block has 6 rotors that transmit their energy to the center accumulator (which could be a 7^{th} rotor). The building block 60a is optimized in terms of weight balance and maximum coupling efficiency. From the cluster 60a, a second level cluster 60b is constructed. The energy from the accumulators of the building block 60a is transmitted to the second level accumulator at the center of nested cluster 60b. Finally, 7 second level nested clusters 60b are used to construct level 3 nested cluster 60.

FIG. 5C presents exemplary array structures that are constructed from nested clusters with topographies chosen from those of FIG. 5A or other topographies with desirable properties. The choice is dictated by the environment in which it is used and the specific application and the power range. For instance, certain sites have the highest wind class and the terrain allows the erection of very tall towers to reach highest wind velocity. In this case the array structure 70a may be used in a farm compromising a plurality of arrays 70, each of which may reach heights well above 200 meter ceiling that is limiting prior art large rotor designs. A single tower 70a may be able to harvest 10M-100 MW or more, according to scaling law of Eq. (36). These power levels are not thought to be possible by means of prior art single large rotor architecture.

At other extreme of the power spectrum, 10 KW-100 KW, array structures 70b, 70c, 70d may use. From these illustrations, it is evident that the inventive array architectures according to the present invention offer a level of flexibility that was possible before. For instance, designing a single small rotor with optimum properties allows the construction of turbines for any power level from 10 KW to 100 MW because of the simple scaling rules derived herein. Prior art architectures require a new design and a new rotor size for different power levels.

1. A reduced mass turbine system comprising:
I. at least one rotor for converting fluid energy wherein said rotor has a radius R, rotates about an axis, and comprises at least one blade;
II. a means for producing said at least one blade so that the mass M_{R}, of at said at least one rotor scales with the cube of the rotor radius R.

2. The system in claim 1 further comprises a nacelle with a mass n relative M_{R}; a tower with mass t relative M_{R}; foundation with mass f relative M_{R} wherein total system mass M_{sym} is produced according to M_{sym}=M_{R}(1+n)(1+t)(1+f).

3. The system of claim 1 where in the means of producing is according to M_{R}=2π ρ̅_{R}BNPᵢR³.

4. The system of claim 2 wherein the system mass scales with the cube of the radius R

5. The system of claim 2 wherein the mass is produced according to M_{sys}=2π ρ̅_{R}BNPᵢR³(1+n)(1+t)(1+f).

6. The system in claim 3 wherein N=NₓN_{y} is a number of rotor elements arranged in a topography within a two dimensional plane structure comprising Nₓ elements on one side and N_{y} elements on the other side.

7. The system in claim 3. wherein N=n_{c} is a cluster of rotor elements arranged a desirable topography in a two dimensional plane.

8. The system in claim 3. wherein N=(n_{c})^{m} is an m^{th} level nested cluster of clusters of rotor elements comprising homogenous cluster topography.

9. The system in claim 1. wherein N=(n_{c})^{m} is an m^{th} level nested cluster of clusters of rotor elements comprising heterogeneous cluster topography.

10. The system in claim 1 wherein N is at least one cluster of rotor elements with symmetric properties.

11. The system in claim 1 wherein N is at least one cluster of rotor elements comprising at least one accumulator and transmission means to accumulate energy from rotor elements and optionally for transmission to the next cluster level.

12. The system in claim 11 wherein the transmission means is at least one mechanical reciprocating transmission line.

13. The system in claim 11 wherein the transmission means is at least one mechanical transmission device.

14. The system in claim 11 wherein the transmission means is at least one electrical transmission line.

15. The system in claim 2 further comprises a means for reducing the system mass by a factor of \sqrt{N}.

16. The system in claim 15 wherein the means for reducing is accomplished by connecting the rotor elements in nested clusters N=(n_{c})^{m} by means of accumulators in each of the m^{th} level cluster.

17. The system in claim 15 wherein the system mass having a reduction factor of \sqrt{N} for each KW, is produced according to:
$${M}_{sys}^{s} / KW = \frac{2 π {\overline{ρ}}_{R} {BP}_{i}}{{ρ}_{o} {C}_{p} {V}^{3} {λ}^{3}} ( \frac{{R}_{L}}{\sqrt{N}} ) ( 1 + n ) ( 1 + t ) ( 1 + f )$$
using N small rotor element clusters which have a sweep area equivalent to that of a large rotors of radius R_{L}.

18. The system of claim 1 wherein the at least one blade of a least one rotor has a mass that is optimized with respect to blade material strength to withstand maximum allowed torque Tₘ and is produced according to:
$${M}_{R} / {T}_{m} = \frac{2 {\overline{ρ}}_{R} / {\overline{τ}}_{s}}{{C}_{p} λ} {S}_{i}$$

19. The system of claim 18 wherein the strength integral Sᵢ is related to the performance integrals Pᵢ according to: Pᵢ/λ=EₘSᵢ

20. Method for reducing turbine system mass comprising the steps of:
I. selecting a site for turbine system operation;
II. providing system specification including: maximum velocity; rated operating velocity; rated output power; expected efficiency; and maximum tip speed velocity;
III. Determining the rotor radius; blade geometry; and the number of blade;
IV. Providing a turbine design comprising at least one rotor comprising at least one blade; at least one tower having at least one foundation wherein the rotor mass is produced according to: M_{R}=2π ρ̅_{R}NR³Pᵢ and
$${M}_{R} / {T}_{m} = \frac{2 {\overline{ρ}}_{R} / {\overline{τ}}_{s}}{{C}_{p} λ} {S}_{i}$$
with the performance integral Pᵢ and strength Sᵢ are related by Pᵢ/λ=EₘSᵢ;
$${P}_{i} ≡ {\int }_{{λ}_{h}}^{λ} \frac{{ρ}_{R} ( {λ}_{r} ) / {\overline{ρ}}_{R}}{{λ}^{3} B} ( ( λ sin α ) [ {λ}_{r} {c}_{f} ( {λ}_{r} ) ] - \frac{{c}_{p} ( {λ}_{r} )}{{λ}_{r}} ) d {λ}_{r} ;$$
$${S}_{i} ≡ {\int }_{{λ}_{h}}^{λ} \frac{{ρ}_{R} / {\overline{ρ}}_{R}}{{τ}_{s} / {\overline{τ}}_{s}} sin α ( {c}_{f} ( {λ}_{r} ) {c}_{p} ( {λ}_{r} ) ) d {λ}_{r} .$$
V. Determining the turbine system mass according to
M_{sym}=M_{R}(1+n)(1+t)(1+f);
VI. Providing means for reducing the turbine system mass

21. The method in claim 20 wherein said at least one rotor comprises at least one nested rotor cluster comprising at least one accumulator.

22. The method in claim 20 wherein the means for reducing turbine system mass comprises the step of arranging at least one nested rotor cluster and at least one accumulator to produce at total mass pre unit power according to:
$${M}_{sys}^{s} / KW = Z ( \frac{{R}_{L}}{\sqrt{N}} ) ( 1 + n ) ( 1 + t ) ( 1 + f )$$
where
$$Z = \frac{2 π {\overline{ρ}}_{R} {BP}_{i}}{{ρ}_{o} {C}_{p} {V}^{3} {λ}^{3}}$$
and R_{L} is the radius of an equivalent large rotor having a swept area πR_{L}² sustainably the same as the area of N substantially smaller rotors arranged in said at least one nested cluster.

23. A Tool for rapid design of turbine rotor blades comprising:
I. A virtual gear structure comprising:
(i)—a fluid flow actuator disc;
(ii)—a first virtual gear set;
(iii)—a second gear set having a least one blade tooth, intermeshing with corresponding teeth of said first virtual gear set, interposed between actuator disc and second gear set;
II. A means provided by first gear set for transmitting rotational mechanical energy to the second gear set from fluid flow energy of actuator disc; wherein said means enables the mass of the second gear set to be determined by a precise cubic relationship with respect to the radius, in addition to its dependence on other turbine rotor parameters.

24. The tool in claim 23, wherein the means for transmitting is linking the virtual gear rotational power to the actuator disc power by the relation
$$δ {P}_{at} = \frac{1}{2} {ρ}_{o} {c}_{p} ( r ) {r}^{2} {A}_{at} d r {ω}^{3}$$
to determine the blade tooth element cross section area according to the relation
$${A}_{st} = {A}_{c} - \frac{2 π {c}_{p} ( r )}{B {λ}_{r}^{3}} {r}^{2} .$$

25. The tool in claim 23, wherein the means for the determining the mass of the blade gear tooth is according to the relation
$${M}_{R} = \frac{2 π {R}^{3}}{{λ}^{3} B} {P}_{i}$$
wherein the value performance integral
$${P}_{i} ≡ {\int }_{{λ}_{h}}^{λ} ρ ( {λ}_{r} ) ( ( λ sin α ) [ {λ}_{r} {c}_{f} ( {λ}_{r} ) ] - \frac{{c}_{p} ( {λ}_{r} )}{{λ}_{r}} ) d {λ}_{r} ;$$
wherein Pᵢ is impendent or the radius.

26. The tool in claim 25, wherein, the blade tooth mass is described by a precise law or formula that scales with cubic power of the radius R.

27. The tool in claim 25, wherein, the blade tooth mass is described by a precise law or formula related to the cube of the radius R and through Pᵢ, to the aerodynamic, rotational dynamics, geometry, structure and material properties of the rotor material.

28. The tool in claim 23, wherein the fluid is chosen from the group: (air, liquid, steam, high pressure gas, combustion, particles).

29. The tool in claim 23, wherein, the means for determining a precise relationship of blade tooth mass with respect to material strength, to withstand maximum allowed torque, is based on the relation between the blade tooth element moment of inertia, maximum torque, material strength and polar moment of inertia according to
δI_{R}=r²δM_{R}=ρLδJ

30. The tool in claim 23, wherein, the means for determining a precise relationship of blade tooth mass with respect to material strength, and maximum allowed torque is determined from
$${M}_{R} / {T}_{m} = \frac{2}{{C}_{p} B λ} {S}_{i} ;$$
where the strength integral Sᵢ is determined from
$${S}_{i} ≡ {\int }_{{λ}_{h}}^{λ} \frac{ρ}{{τ}_{s}} sin α ( {c}_{f} ( {λ}_{r} ) {c}_{p} ( {λ}_{r} ) ) d {λ}_{r} .$$
which is independent of the radius

31. The tool in claim 23, further comprises a means for matching the blade mass design performance and strength from the integrals Sᵢ, and Pᵢ in a self consistent manner, using the same set of parameters, c_{f}(λᵣ) and cₚ(λᵣ), yielding balanced rotor designs that are optimized not only for performance but also for strength and reliability.

32. A method for the rapid and accurate design of turbine rotor blades comprising the steps of:
1. Providing the nominal operating power and allowable power;
2. Determining the rotor radius, number of blades and rotor material strength to weight ratio
$$\frac{ρ}{{τ}_{s}} ,$$
3. Determining the optimum blade mass design in terms how it scales with aerodynamic, rotational dynamic parameters on the one hand, and with geometry structure and material parameters on the other following the following algorithm:
i)—Providing a design tool using a virtual gear structure comprising:
(a)—a fluid flow actuator disc;
(b)—a first virtual gear set;
(c)—a second gear set having a least one blade tooth, intermeshing with corresponding teeth of said first virtual gear set, interposed between actuator disc and second gear set;
ii)—Linking the local (at radius r) rotational dynamics of the virtual air gear teeth 4, to the actuator disc dynamics by means of equating the local rotational power of the virtual gear teeth 4, to the local fraction cₚ(r) of the rotational power in the actuator disc 3.
iii)—Determining the virtual gear cross section area
$${A}_{at} = \frac{2 π {c}_{p} ( r )}{B {λ}_{r}^{3}} {r}^{2}$$
iv))—Determining the blade element cross section area Aₛₜ=A_{c}−Aₐₜ
$${A}_{st} = {A}_{c} - {A}_{at} = {A}_{c} - \frac{2 π {c}_{p} ( r )}{B {λ}_{r}^{3}} {r}^{2} .$$
v)—Determining the blade element mass
$$δ {M}_{R} = ρ ( r ) {A}_{st} dr = ρ ( r ) ( {A}_{c} - \frac{2 π {c}_{p} ( r )}{B {λ}_{r}^{3}} {r}^{2} ) dr . ,$$
vi)—By integration, the whole mass of the single blades is calculated
$${M}_{R} = {\int }_{{r}_{h}}^{R} ρ ( r ) ( {A}_{c} - \frac{2 π {c}_{p} ( r )}{B {λ}_{r}^{3}} {r}^{2} ) dr ;$$
vii)—Letting
$$\frac{{λ}_{r}}{λ} = \frac{r}{R} , and \frac{d {λ}_{r}}{λ} = \frac{dr}{R}$$
and c_{f}(λᵣ)=c(r)/R, in step v, to find the mass scaling law
$${M}_{R} = 2 π {R}^{3} {\int }_{{λ}_{h}}^{λ} \frac{ρ ( {λ}_{r} )}{{λ}^{3} B} ( ( λ sin α ) [ {λ}_{r} {c}_{f} ( {λ}_{r} ) ] - \frac{{c}_{p} ( {λ}_{r} )}{{λ}_{r}} ) d {λ}_{r}$$
iix)—Defining the performance integral
$${P}_{i} ≡ {\int }_{{λ}_{h}}^{λ} ρ ( {λ}_{r} ) ( ( λsinα ) [ {λ}_{r} {c}_{f} ( {λ}_{r} ) ] - \frac{{c}_{p} ( {λ}_{r} )}{{λ}_{r}} ) d {λ}_{r}$$
simplifies the mass scaling law as
$${M}_{R} = \frac{2 π {R}^{3}}{{λ}^{3} B} {P}_{i} ,$$
revealing the pure cube relationship with the radius;
ix)—Designing rotor blade according to the step viii based on the knowledge of the local shape of the airfoil c_{f}(λᵣ)=c(r)/R and the local power coefficient cₚ(λᵣ) and after performing integration step.
4. Determining the optimum blade mass design in terms how it scales material stenght to withstand the maximum allowable torque, by following the algorithm:
i)—Producing the moment of inertia δI_{R} of the local blade tooth element at poin r, δI_{R}=r²δM_{R}=ρLδJ.
ii)—Calculating the polar moment of inertia from the maxium torque and the material shear strength: δJ=δTₘr/τₛ
iii)—Finding the blade mass element using steps i and ii
δM_{R}=ρRc_{f} sin α δTₘ/r τₛ.
iv)—Determining the maximum torque element
δTₘ=δPₐₜ/ωₘ=πρ₀(cₚ(r)Vₘ²r²dr/λᵣB)
v)—The blade mass element becomes
$$δ {M}_{R} = \frac{{πρρ}_{o} {V}_{m}^{2} {R}^{3}}{B {λ}^{3}} \frac{ρ}{{τ}_{s}} sin α ( {c}_{f} {c}_{p} ( r ) d {λ}_{r} ) ;$$
vi)—Integrating step the expression in v, the whole single blade mass is determined
$${M}_{R} = \frac{{πρ}_{o} {V}_{m}^{2} {R}^{3}}{B {λ}^{3}} {\int }_{{λ}_{h}}^{λ} \frac{ρ}{{τ}_{s}} sin α ( {c}_{f} {c}_{p} ( r ) ) d {λ}_{r} .$$
vii)—We divide the mass by the rotor maximum torque Tₘ=0.5πρₒCₚ(λ)Vₘ²R³/λ². to obtain the desired blade mass design
$${M}_{R} / {T}_{m} = \frac{2}{{C}_{p} B λ} {\int }_{{λ}_{h}}^{λ} \frac{ρ}{{τ}_{s}} sin α ( {c}_{f} ( {λ}_{r} ) {c}_{p} ( {λ}_{r} ) ) d {λ}_{r} \cdot = \frac{2}{{C}_{p} B λ} {S}_{i}$$
where the strength integral is defined as
$${S}_{i} ≡ {\int }_{{λ}_{h}}^{λ} \frac{ρ}{{τ}_{s}} sin α ( {c}_{f} ( {λ}_{r} ) {c}_{p} ( {λ}_{r} ) ) d {λ}_{r} .$$
5. obtaining a balanced turbine blade design, matching the blade mass design performance and strength from the integrals Sᵢ, and Pᵢ in a self consistent manner, using the same set of parameters, c_{f}(λᵣ) and cₚ(λᵣ), in
$${M}_{R} / {T}_{m} = \frac{2}{{C}_{p} B λ} {S}_{i} and {M}_{R} = \frac{2 π {R}^{3}}{{λ}^{3} B} {P}_{i} .$$
6. One or more iterative steps may be required in step 5, varying parameters and calculating the integrals until a match is found that yields balanced rotor designs that are optimized not only for performance but also for strength and reliability.
